(19) United States
(12) Patent Application Publication
(10) Pub. No.: US 2009/0183161 A1
(43) Pub. Date: Jul. 16, 2009

(54) CO-PROCESSOR FOR STREAM DATA PROCESSING

(76) Inventors: Pasi Kolinummi, Kangasala (FI); Juhani Vehvilainen, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/015,371

(22) Filed: Jan. 16, 2008

(51) Int. Cl. G06F 9/46; G06F 9/30

(52) U.S. Cl. 718/102; 712/32

(57) ABSTRACT

An architecture is shown where a conventional direct memory access structure is replaced with a latency tolerant programmable direct memory access engine, or co-processor, that can handle multiple demanding data streaming operations in parallel. The co-processor concept includes a latency tolerant programmable core with any number of tightly coupled auxiliary units. The co-processor operates in parallel with any number of host processors, thereby reducing the host processors' load as the co-processor is configured to autonomously execute assigned tasks.

### BACKGROUND OF THE INVENTION

1. Technical Field

The present invention pertains to the field of data computation. More particularly, the present invention pertains to a new architecture that can handle multiple demanding data streaming operations in parallel.

2. Discussion of related art

Data ciphering is an increasingly important aspect of wireless data transfer systems.

User demand for increased personal privacy in cellular communications has prompted the standardization of a variety, of ciphering algorithms. Examples of contemporary block and stream wireless cipher algorithms include 3GPP™ Kasumi F8 & F9, Snow UEA2 & UIA2, and AES.

In a ciphered communication session, both the uplink and downlink data streams require processing. From the point of view of the remote terminal, before being sent in the uplink direction, data is ciphered. In the downlink direction, the data is deciphered after receipt in the mobile terminal. To this end ciphering algorithms are presently implemented using software and general purpose processors. Legacy solutions for carrying out ciphering in a mobile terminal call for a host processor or Direct Memory Access (DMA) device serially processing the data streams. Incoming ciphered data is identified and stored in memory. The host processor or DMA device reads ciphered data from memory, writes it to a peripheral device adapted to execute the ciphering algorithm, waits until the peripheral device has completed the operation, reads the processed data from the peripheral device and writes it back to memory. The resultant host processor load is proportional to the transmission speed of the data streams. This procedure loads the host processor for the entire cycle and can result in poor performance as a result of time consuming and repetitive data copying.

Power consumption tends to be less efficient in the prior art solution given the numerous data transfers and significant processor overhead. Peripheral acceleration techniques are thought to be unsuitable for high speed data transfer as it results in a high host processor load. In a High-Speed Data Access (HSDPA) network, the Kasumi algorithm may occupy up to 33% of a contemporary processors available clock cycles. In faster environments. such as the 100 Mbit per second downlink/50 Megabit per second uplink Evolved Universal Terrestrial Radio Access Network (EUTRAN) the peripheral acceleration approach is simply infeasible with currently available hardware.

As it is believed that legacy solutions are inadequate for enabling effective ciphering in high-speed cellular communication environments, what is needed is an efficient architecture for minimizing host processor loading by allowing autonomous parallel processing of streaming data by a DMA device.

Direct memory access is a technique for controlling a memory system while minimizing host processor overhead. On receipt of a stimulus such as an interrupt signal, typically from a controlling processor, a DMA module will move data from one memory location to another. The idea is that the host processor initiates the memory transfer, but does not actually conduct the transfer operation, instead leaving performance of the task to the DMA module which will typically return an interrupt to the host processor when the transfer is complete.

There are many applications (including data ciphering) where automated memory access is potentially much faster than using a host processor to manage data transfers. The DMA module can be configured to handle moving the collected data out of the peripheral module and into more useful memory locations. Generally, only memory can be accessed this way, but most peripheral systems, data registers, and control registers are accessed as if they were memory. DMA modules are also frequently intended to be used in low power modes because a DMA module typically uses the same memory bus as the host processor and only one or the other can use the memory at the same time.

Although prior art ciphering solutions have utilized DMA modules, none appear to allow for simultaneous data transfer and data processing to occur within a single module, thereby necessitating inefficient serial processing within the DMA module.

The closest identified prior art solution is U.S. Pat. No. 6,438,678 to Cashman et al. (hereinafter Cash man). Cash man teaches a programmable communication device having a co-processor with multiple programmable processors allowing data to be operated on by multiple protocols. A system equipped with the Cashman device can handle multiple simultaneous streams of data and can implement multiple protocols on each data stream. Cashman discloses the co-processor utilizing a separate and external DMA engine controlled by the host processor for data transfer, but includes no disclosure of means for allowing data transfer and data processing to be carried out by the same device.

### DISCLOSURE OF INVENTION

It is an object of the invention to allow for data transfer and data processing to be carried out simultaneously in the same device, thereby allowing autonomous latency tolerant pipelined operations without any need for loading the host processor and DMA engine.

According to a first aspect of the disclosure, an electronic device comprises:

a co-processor responsive to a message signal from a host processor, the co-processor configured for data transfer and data processing in parallel and further configured to return a message signal to the host processor once the processing is complete; and

one or more auxiliary units bi-directionally connected to the co-processor and configured to execute in whole or in part the data processing in response to a message signal from the co-processor, and further configured to return a message signal to the co-processor once the processing is complete.

Electronic device of claim 1, wherein the one or more auxiliary units and co-processor are configured to support multithreading and further configured to process multiple tasks in parallel.

In the electronic device according to the first aspect, the co-processor may be configured to distribute data processing operations to the one or more auxiliary units, wherein the co-processor is configured to continue processing other operations until the co-processor is ready to use the result of the one or more auxiliary units' data processing. One or more auxiliary units may be connected directly to the co-processor using a packet based interconnect.

The device according to the first aspect may further comprise a co-processor register bank wherein each of the one or more auxiliary units is configured to write data processing results to the co-processor register bank, wherein the electronic device is configured to mark as affected those registers in the co-processor register bank utilized by the one or more auxiliary units, and wherein the co-processor is configured to stall if the co-processor attempts to use register values that are marked as affected but have not yet been updated to reflect the results of the one or more auxiliary units' data processing.

In the device according to the first aspect the one or more auxiliary units may be configured to perform an operation associated with a tag, and may further be configured to return a corresponding result with the same tag.

In the device according to the first aspect, the one or more auxiliary units may be configured to execute one or more data ciphering algorithms.

In the device according to the first aspect, the co-processor may be configured to perform another task or another part of the same task if the one or more auxiliary units have not yet completed processing.

In the device according to the first aspect, may be configured for use in a mobile terminal.

In the device according to the first aspect, each of the one or more auxiliary units may be configured to process one or more data ciphering algorithms' key generating core to generate a cipher key. The co-processor may combine the cipher key generated by the auxiliary unit with ciphered data.

According to a second aspect of the disclosure a system comprises:

one or more host processors;

one or more memory units;

a co-processor responsive to a message signal from a host processor, the co-processor configured for data transfer and data processing in parallel and further configured to return a message signal to the host processor once the processing is complete, the co-processor connected to the one or more host processors and one or more memory units via a pipelined interconnect;

one or more auxiliary units bidirectionally connected to the co-processor and configured to execute in whole or in part the data processing in response to a message signal from a host processor, and further configured to return a message signal to the co-processor once the processing is complete.

In the system, the one or more auxiliary units and co-processor may be configured to support multithreading and may further be configured to process multiple tasks in parallel.

The co-processor may be configured to distribute data processing operations to the one or more auxiliary units, wherein the co-processor may be configured to continue processing other operations until the co-processor is ready to use the result of the one or more auxiliary units' data processing.

The one or more auxiliary units may be connected directly to the co-processor using a packet based interconnect.

The system may further comprise:

a co-processor register bank;

wherein each of the one or more auxiliary units is configured to write data processing results to the co-processor register bank.

wherein the electronic device is configured to mark as affected those registers in the co-processor register bank utilized by the one or more auxiliary units, and

wherein the co-processor is configured to stall if the co-processor attempts to use register values that are marked as affected but have not yet been updated to reflect the results of the one or more auxiliary units' data processing.

According further to the second aspect, at least one of the one or more host processors and co-processor may, operate in parallel.

Still further in accord with the second aspect, at least one of the one or more host processors may be configured to distribute data processing operations to the co-processor, wherein the at least one of the one or more host processors may be configured to continue processing other operations until read) to use the result of the co-processor's data processing.

According to a third aspect of the disclosure, a method, comprises:

receiving a message signal containing code or parameters relating to a task from a host processor to a co-processor, the co-processor configured for data transfer and data processing in parallel,

downloading the code to a memory block, or running code available in the memory block or a cache by the co-processor,

executing the task by the co-processor, and

informing the host processor of the completed task.

The method of the third aspect may further comprise allocating a portion of the task to one or more auxiliary units for processing. The method may further comprise:

marking as affected those registers in a co-processor register bank utilized by the one or more auxiliary units,

writing the result of the processing of the portion of the task to a co-processor register bank; and

stalling the co-processor if the co-processor attempts to use register values that are marked as affected but have not yet been updated to reflect the result of the processing of the portion of the task.

According to a fourth aspect of the disclosure, an electronic device comprises:

means for receiving a message signal containing code or parameters relating to a task from a host processor to a co-processor, the co-processor configured for data transfer and data processing in parallel;

means for downloading the code to a memory block, or running code available in the memory block or a cache by the co-processor;

means for executing the task by the co-processor; and

means for informing the host processor of the completed task.

The electronic device according to the fourth aspect may further comprise means for allocating a portion of the task to one or more auxiliary units for processing. Such an electronic device ma) further comprise:

means for marking as affected those registers in a co-processor register bank utilized bit the one or more auxiliary, units,

means for writing the result of the processing of the portion of the task to a co-processor register bank, and

means for stalling the co-processor if the co-processor attempts to use register values that are marked as affected but have not yet been updated to reflect the result of the processing of the portion of the task.

According further to the fourth aspect, the one or more auxiliary units may comprise one or more programmable gate arrays.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a system level illustration of the co-processor data streaming architecture.

FIG. 2 is a flow diagram showing a prior art ciphering solution, where the host processor is fully loaded for the entire ciphering operation and data transfer takes more time than actual computation.

FIG. 3 is a flow diagram of basic task execution in the disclosed system.

FIG. 4 is an internal block diagram of the system co-processor.

FIG. 5 is flow diagram showing execution of instructions by the co-processor.

FIG. 6 is a diagram illustrating a possible grouping of signals for controlling an auxiliary unit.

FIG. 7 illustrates in a simplified block diagram an embodiment of auxiliary unit configured for Kasumi f8 ciphering.

### DETAILED DESCRIPTION

The invention encompasses a novel concept for hardware assisted processing of streaming data. The invention provides a co-processor having one or more auxiliary units, wherein the co-processor and auxiliary units are configured to engage in parallel processing. Data is processed in a pipelined fashion providing latency tolerant data transfer. The invention is believed to be particularly suitable for use with advanced wireless communication using ciphering such as but not limited to 3GPP™ ciphering algorithms. Thus, it may be used with algorithms implementing other ciphering standards or for other applications where latency tolerant parallel processing of streaming data is necessary or desirable.

The co-processor concept includes a latency tolerant programmable core with any number of tightly coupled auxiliary units. The co-processor and host processors operate in parallel, reducing the host processor's load as the co-processor is configured to autonomously execute assigned tasks. Although the co-processor core includes an arithmetic logic unit (ALU), the algorithms run by the co-processor are typically simple microcode or firmware programs. The co-processor also serves as a DMA engine. The principal idea is that data is processed as it is transferred. This idea is the opposite of the most commonly used method, whereby data is first moved with DMA to a module or processor for processing, then once processing is complete, the processed data is copied back with DMA again.

The co-processor is configured to function as an intelligent DMA engine which can keep high throughput data transfer and at the same time process the data. Data processing and data transfer occur in parallel even though the logical operations are controlled by one program.

Data can be processed either by the co-processor ALU or the connected auxiliary, units. Although the auxiliary units may execute any operation, the auxiliary units are generally configured to process repetitive core instructions of a ciphering algorithm i.e. generating a cipher key. Control of the algorithm is handled by the co-processor. For data ciphering, this solution is believed to yield satisfactory performance while efficiently managing energy consumption. This approach further simplifies algorithm development and streamlines implementation of new software. For further adaptability, Programmable Gate Array (PGA) logic may also be added to the auxiliary units to allow for later hardware implementation of additional algorithms.

Similar strategies may be used for all other algorithms. There can be multiple auxiliary units associated with one co-processor and each can operate in parallel. To further increase parallelism, the co-processor may be configured to support multithreading. Multithreading is the ability to divide a program into two or more simultaneously (or pseudo-simultaneously) running tasks. This is believed to be important for real time systems wherein multiple data streams are simultaneously transmitted and received. WCDMA and EUTRAN, for example, provide for uplink and downlink streams operating at the same time. This could be most efficiently handled with a separate thread for each stream.

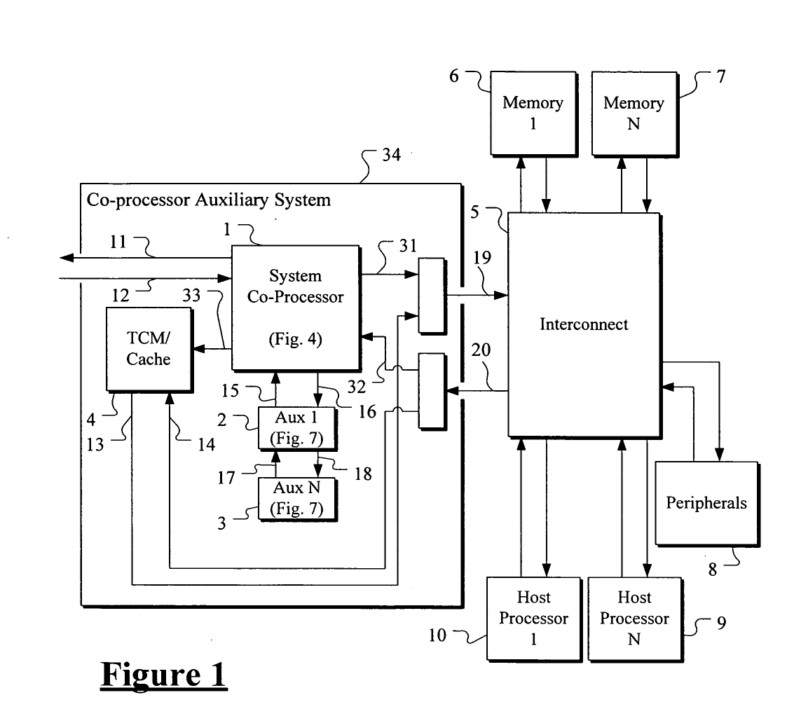

FIG. 1 illustrates a system level view of an exemplary co-processor implementation according to the teachings hereof. Here, as in most system-on-chip Application Specific Integrated Circuits (ASICs), one or more host processors 9, 10 and one or more memory components 6, 7 are present. The memory, modules can be integrated or external to the chip. Peripherals 8 may be used to support the host processors. They can include timers, interrupt services, IO (input-output) devices etc. The memory modules, peripherals, host processors, and co-processor are bidirectionally connected to one another via a pipelined interconnect 5. The pipelined interconnect is necessary because the co-processor is likely to have multiple outstanding memory operations at any given time.

The co-processor auxiliary system 34 is shown on the left of FIG. 1. It includes a system co-processor 1 and multiple auxiliary units 2, 3. Any number of auxiliary units may be present. The idea is that one central system co-processor can simultaneously serve multiple auxiliary units without significant performance degradation.

An auxiliary unit may, for example, be thought of as an external ALU. In one embodiment, the auxiliary unit interface, connecting the auxiliary units to the coprocessor, may support a maximum of four auxiliary units, each of which may implement up to sixty-four different instructions, each of which may operate on a maximum of three word-sized operands and may produce a result of one or two words. The interface may support multiple-clock instructions, pipelining and out-of-order process completion. To provide for high data transmission rates, the auxiliary units may be connected directly to the co-processor using a packet based interconnect 15, 16, 17, 18. The co-processor's auxiliary unit interface comprises of two parts: the command port 16 and the result port 15. Whenever a thread executes an instruction targeting an auxiliary unit, the co-processor core presents the operation and the operand values fetched from general registers along the command port, along with a tag. The accelerator addressed by the command should store the tag and then, when processing is complete, produce a result with the same tag. The ordering of the returned results is not significant as the co-processor core uses the tag only for identification purposes.

To simplify external monitoring and control of the co-processor, the device is configured receive synchronization and status input signals 12 and respond with status output signals 11. The co-processor's state can be read during execution of a thread, and threads can be activated, put on hold, or otherwise prioritized based upon the state of 12. Signal lines 11 and 12 may be tied to interconnect 5, directly to a host processor, or to any other external device.

The co-processor auxiliary system may further include a integral Tightly Coupled Memory (TCM) module or cache unit 4 and a request 19 and response data bus 20. The system co-processor outputs a signal to the request data bus over line 31, and receives a signal from the response data bus over line 32. The TCM/cache is configured to receive a signal from the system co-processor on a line 33, and also a signal from the response data bus on line 14. The TCM may output a signal to the request data bus over line 13. The data busses 19 & 20 further connect the system-coprocessor to the system interconnect 5. FIG. 1 further illustrates that the co-processor may retrieve and execute code from the TCM/cache.

Applicants' preferred embodiment ciphering accelerator system includes a co-processor and specialized auxiliary units specifically adapted for Kasumi, Snow and AES ciphering. As ciphering/deciphering utilize the same algorithm, the same auxiliary units may be used for both tasks. All Kasumi based algorithms are supported e.g. 3GPP F8 and F9, GERAN A5/3 for GSM/Edge and GERAN GEA3 for GPRS. Similarly, all Snow based algorithms are supported, e.g. Snow algorithm UEA2 and UIA2. Auxiliary units may be fixed and non-programmable. They may be configured only to process the cipher algorithms' key-generating core, as defined in 3GPP™ standards. The auxiliary units do not combine ciphered data with the generated key. Stream encryption/decryption is handled by the co-processor.

The system allows for multiple discrete algorithms to operate at the same time, and the system is tolerant of memory latency. System components may read or write to or from v an other component in the system. This is intended to decrease system overhead as components can read and write data at their convenience. The system is able, for example, to have four threads. Although thread allocation may vary, two threading examples are provided below:

### EXAMPLE 1

Thread 1: Downlink (HSDPA) Kasumi processing (e.g. f8 or f9)

Thread 2: Uplink (HSUPA) Kasumi processing (e.g. f8)

Thread 3: Advanced Encryption Standard (AES) processing for application ciphering

Thread 4: CRC32 for TCP/IP processing

### EXAMPLE 2

Thread 1: Downlink (HSDPA) Snow processing

Thread 2: Uplink (HSUPA) Snow processing

Thread 3: AES processing for application ciphering

Thread 4: CRC32 for TCP/IP processing

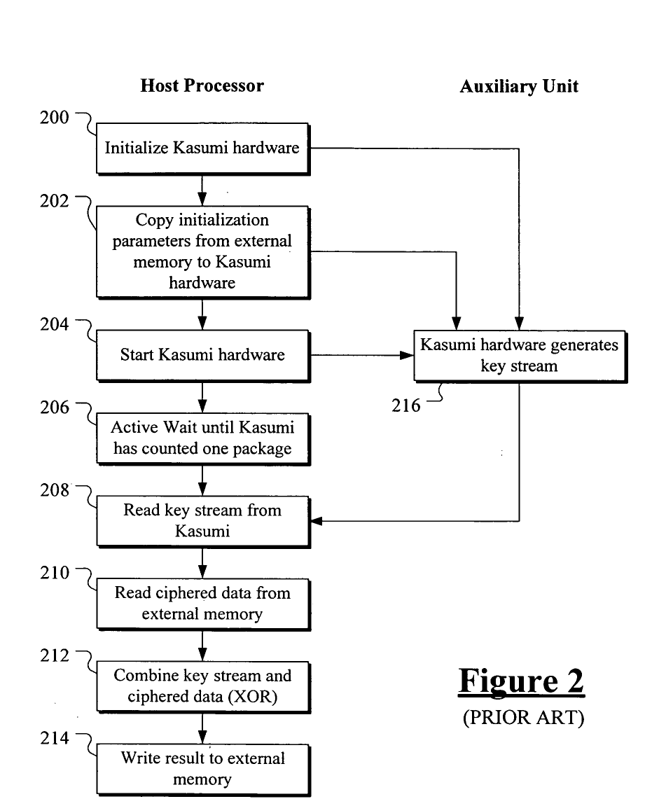

FIG. 2 illustrates the flow of prior art systems utilizing peripheral acceleration techniques. As is shown, the host processor first initializes 200 the accelerator, copies initialization parameters 202 from external memory to the accelerator, instructs the accelerator 204 to begin processing, and then actively waits 206 until the accelerator has generated the required key stream 216. The host processor then reads the key stream 208 from the accelerator, reads the ciphered data 210 from external memory combines the key stream 212 with the ciphered data using the XOR logical operation to decipher the data, and writes the result 214 to external memory. The host processor is loaded during the entire cycle except when it is actively waiting (and thereby unable to process other tasks).

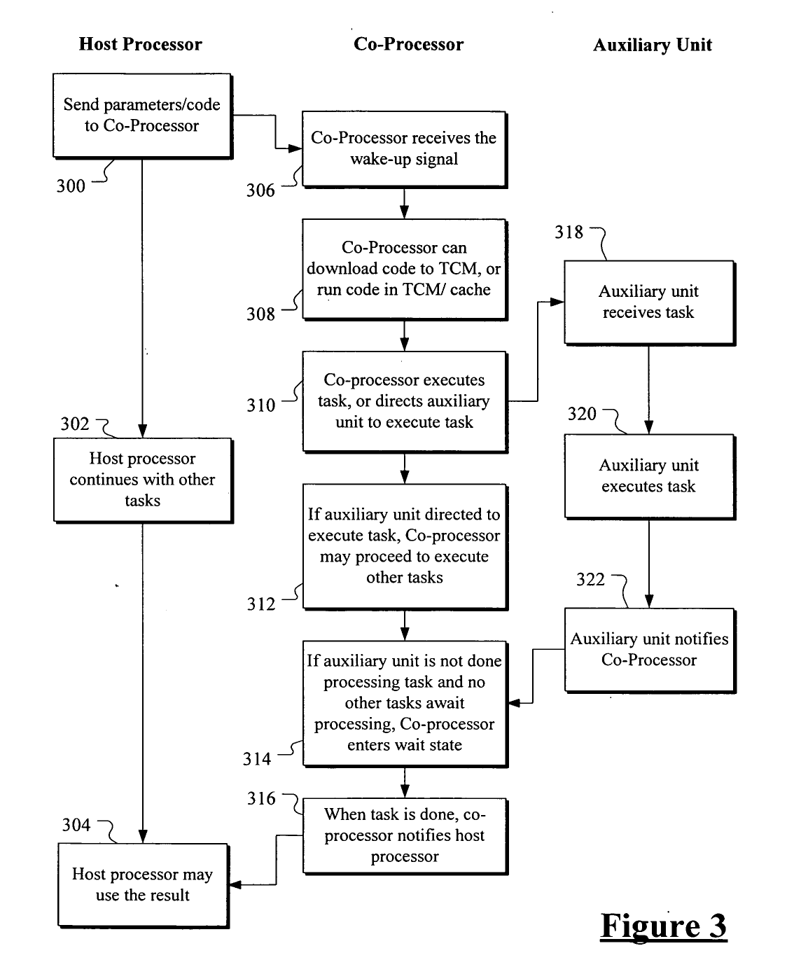

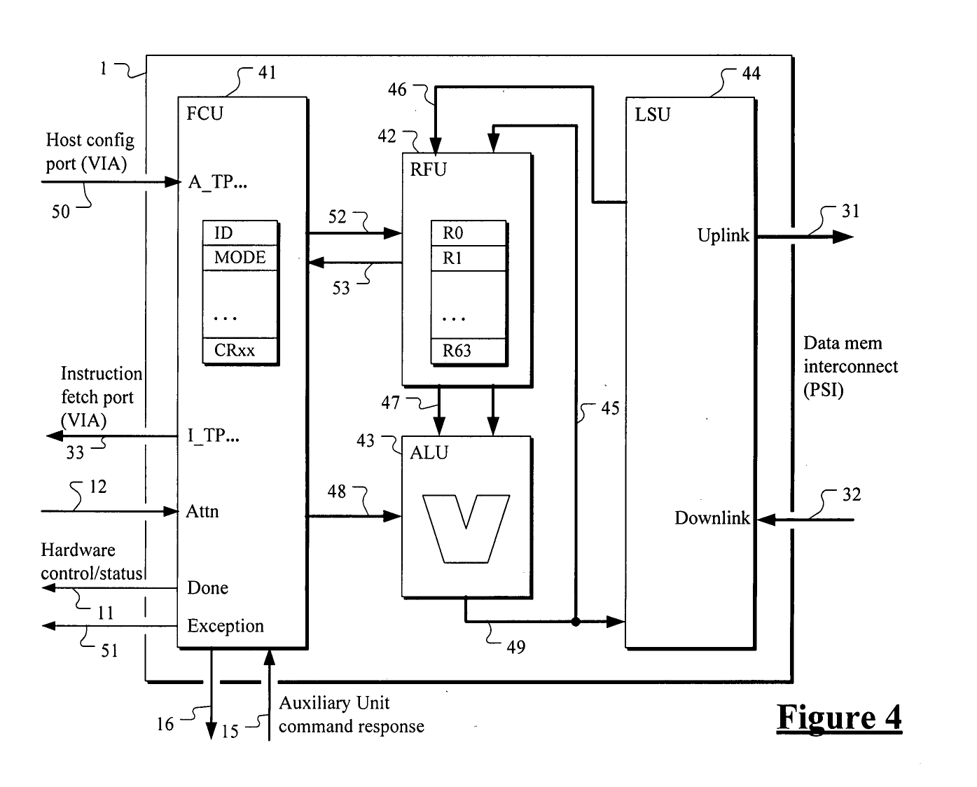

FIG. 3 illustrates the inventive interaction between a host processor, co-processor and an auxiliary unit. Generally, after a wake-up signal is received from the host processor at steps 300 and 306 across line 32, the co-processor will process the header/task list and ask load-store unit (LSU) 44 (See FIG. 4) to fetch needed data 308. Data may be forwarded to—and received by—auxiliary units for processing in operations 310 and 318. The auxiliary units may process data at step 320 while the load store unit fetches new data, or outputs processed data. The co-processor may continue to process other tasks at step 312 while waiting for the auxiliary units to complete processing. When the auxiliary unit has completed processing, it notifies the co-processor at step 322. In the case of a ciphered stream data, the auxiliary units generate the key stream which is then combined with the ciphered data by the co-processor. The combination can be done while the auxiliary unit is processing another data block. When the task is complete, the co-processor then notifies the host processor (% which may have been simultaneously executing other tasks at step 302) of the available result for use by the host processor at steps 316 and 304.

Performance of the auxiliary, unit is therefore likely to bear favorably on overall performance of the co-processor. Although the co-processor stream data processing concept is particularly suited to ciphering applications, the co-processor solution may be advantageously adapted for use with any algorithm requiring repetitive processing. Further, there is no requirement that auxiliary units be utilized at all step 310, although in that case performance and power consumption penalties may be incurred if the system programmer makes inefficient use of available resources i.e. programs the co-processor to perform both key generation and stream combination. The co-processor may enter a wait state if no further tasks are available and auxiliary unit operations remain outstanding at step 314.

FIG. 4 illustrates a more detailed embodiment of the system co-processor 1 shown in FIG. 1 as well as the connections to the auxiliary units and other system components. Each of the co-processor components may be configured to operate independently.

The Register File Unit (RFU) 42 maintains the programmer-visible architectural state (the general registers) of the co-processor. It may contain a scoreboard which indicates the registers that have a transaction targeting them in execution. In an exemplary embodiment, the RFU may support three reads and two writes per clock cycle—one of the write ports may be controlled by a Fetch and Control Unit (FCU) 41, the other ma; be dedicated to a Load/Store Unit 44. The RFU is bi-directionally connected to the Fetch and Control Unit over lines 52, 53. The RFU is configured to receive signals from the Arithmetic/Logic Unit 43 and Load/Store Unit 44 over lines 49 & 46, respectively.

The Load/Store Unit (LSU) 44 controls the data memory port of the co-processor. It maintains a table of load/store slots, used to track memory transactions in execution. It may initiate the transactions under the control of the FCU but complete them asynchronously in whatever order the responses arrive over line 32. The LSU is configured to receive a signal from the Arithmetic/Logic Unit over the line 49.

The Arithmetic/Logic Unit (ALU) 43 implements the integer arithmetic/logic/shift operations (register-register instructions) of the co-processor instruction set. It may also be used to calculate the effective address of memory references. The ALU receives signals from the RFU and Fetch and Control Unit 41 over lines 47 & 48, respectively.

The Fetch and Control Unit (FCU) 41 can read new instructions while the ALU 43 is processing and Load-Store Unit (LSU) is making reads/writes. Auxiliary units 2, 3 may operate at the same time. They may all use the same register file unit 42. Auxiliary units 2, 3 may also have independent internal registers. The FCU 41 may receive data from a host processor 9, 10 or external source over the Host config port 50, fetch instructions over the instruction fetch port 33, and report exceptions over line 51.

The co-processor's programmer-visible register interface may be accessed over signal line 50. As each co-processor register is a potentially readable and/or writable location in the address space, the, may be directly managed by an external source.

Parallel operation of the LSU, ALU and auxiliary units is essential to maintaining efficient data flow in the co-processor system.

The auxiliary units are configured to process the data and return a result to the co-processor when processing is complete. The co-processor, however, need not wait for a response from the auxiliary units. Instead (if programmed appropriately), as shown in step 312 of FIG. 3, it can continue processing other tasks normally until it needs to use the result of the auxiliary unit.

Each auxillary unit may have its own state and internal registers, but the auxillary units will directly write results to the co-processor register bank that may be situated in RFU 42. The co-processor maintains a fully hardware controlled list of affected registers. Should the co-processor attempt to use register values that are marked as affected prior to the auxiliary unit writing the result, the co-processor will stall until the register value affected by the auxiliary unit is updated. This is intended as a safety feature for operations requiring a variable number of clock cycles. Ideally, the system programmer will utilize all co-processor clock cycles by configuring the co-processor to perform another task or another part of the same task while the auxiliary unit completes processing, thereby obviating this functionality.

Similarly, parameters to the auxiliary units are written from the co-processor register set which may be found in RFU 42. Auxiliary units operate independently and in parallel but are controlled by the co-processor.

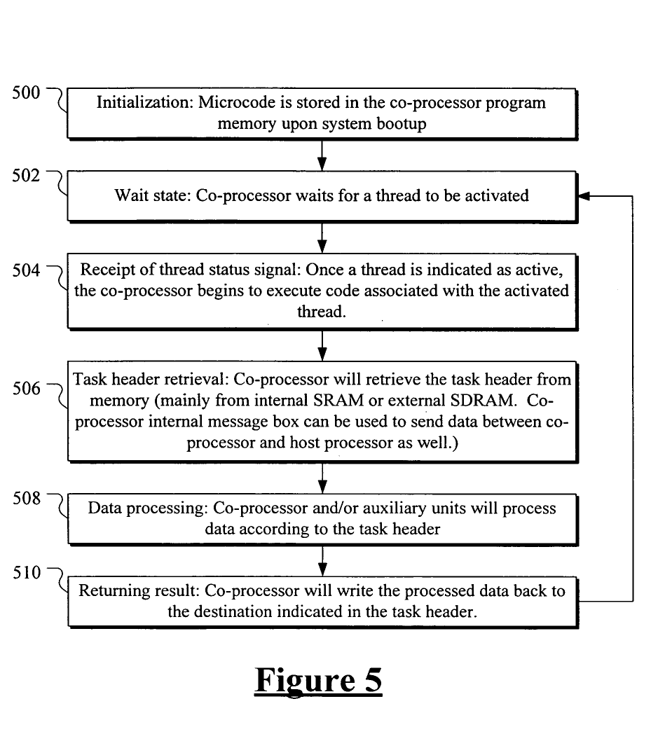

FIG. 5 illustrates a possible execution of code by the Co-processor.

In a first initialization step 500, micro code is loaded into the co-processors program memory 4 upon startup of the device. The co-processor then waits 502 for a thread to be activated. Upon receipt 504 of a signal on line 32 indicating an active thread, the co-processor starts to execute code associated with the activated thread. The co-processor retrieves 506 a task header from either co-processor memory 4 or system memory 6, 7, and then either processes 508 the data according to the header e.g. Kasumi f8 algorithm, or activates an auxiliary unit to perform the operation. Once processing is complete, the co-processor will write 510 the processed data back to the destination specified in the task header, which could for example be system memory 6 or 7 of FIG. 1. The co-processor will then wait 502 for another thread to become active. If multiple threads are active simultaneously, they can be run in parallel by distributing the computational burden to the auxiliary units operating in parallel. Should two or more threads be active at the same time requiring the same auxiliary unit, they may be required to run sequentially.

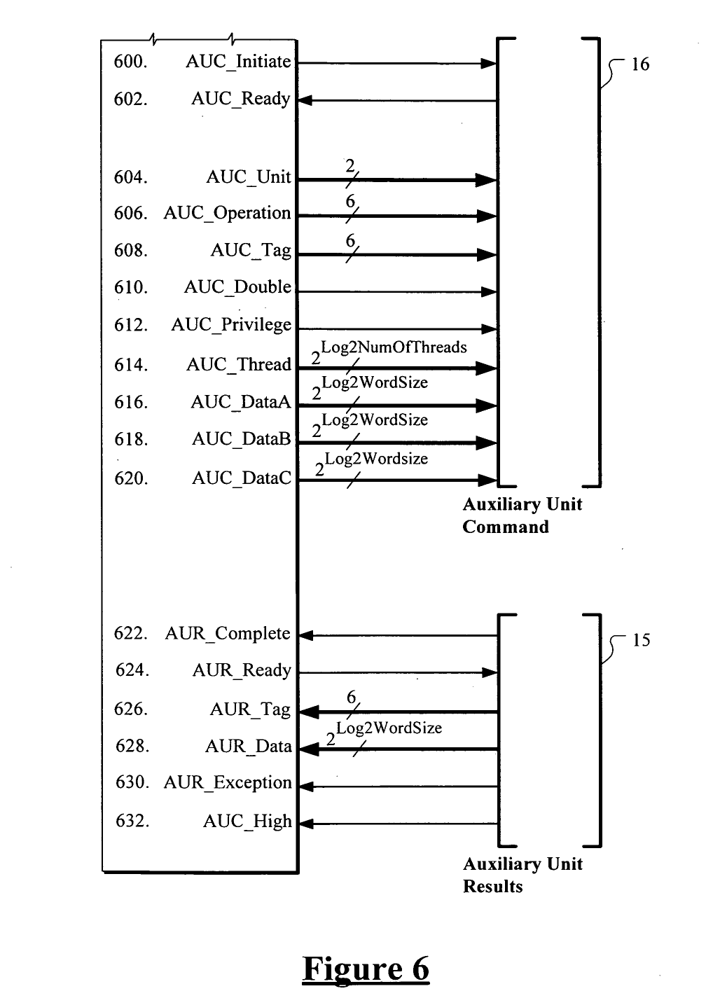

FIG. 6 illustrates an exploded view of command and result ports 16 and 15, showing one potential grouping of signals for controlling auxiliary units.

The AUC_Initiate 600 is asserted whenever the co-processor core initiates an auxiliary, unit operation. The AUC_Unit 604 port identifies the auxiliary unit and AUC_Operation 606, the opcode of the operation. AUC_DataA 616, AUC_DataB 618, AUC_DataC 620 carry the operand values of the operation. AUC_Privilege 612 is asserted whenever the thread initiating the operation is a system thread. AUC_Thread 614 identifies the thread initiating the operation, thus making it possible for an auxiliary unit to support multiple threads of execution transparently. AUC_Double 610 is asserted if the operation expects a double word result.

Every auxiliary unit operation is associated with a tag, provided by the AUC_Tag 608 output. The tag should be stored by the auxiliary unit as it should be able to produce a result with the same tag.

The auxiliary unit subsystem indicates if it can accept the operation by using the AUC_Ready 602 status signal. If the input is negated when an operation is initiated then the core makes another attempt to initiate the operation on the next clock cycle.

Every operation accepted by an auxiliary unit should produce a result of one or two words, communicated back to the core through the result port 15. The AUR_Complete 622 signal is asserted to indicate that a result is available. The operation associated with the result is identified by the AUR_Tag 626 value which is the same as provided at 608 and stored by the auxiliary unit. A single-word operation should produce exactly one result with the AUR_High 632 negated, a double-word operation should produce exactly two results, one with the AUR_High negated (the low-order word) and one with AUR_High asserted (the high-order word). AUR_Data 628 indicates the data value associated with the result and AUR_Exception 630 indicates if the operation completed normally and produced a valid result (AUR_Exception=0) or if the result is invalid or undefined (AUR_Exception=1).

The AUR_Ready 624 status output is asserted whenever the core can accept a result on the same clock cycle. A result presented on the result port when AUR_Ready is negated is ignored by the co-processor and should be retried later.

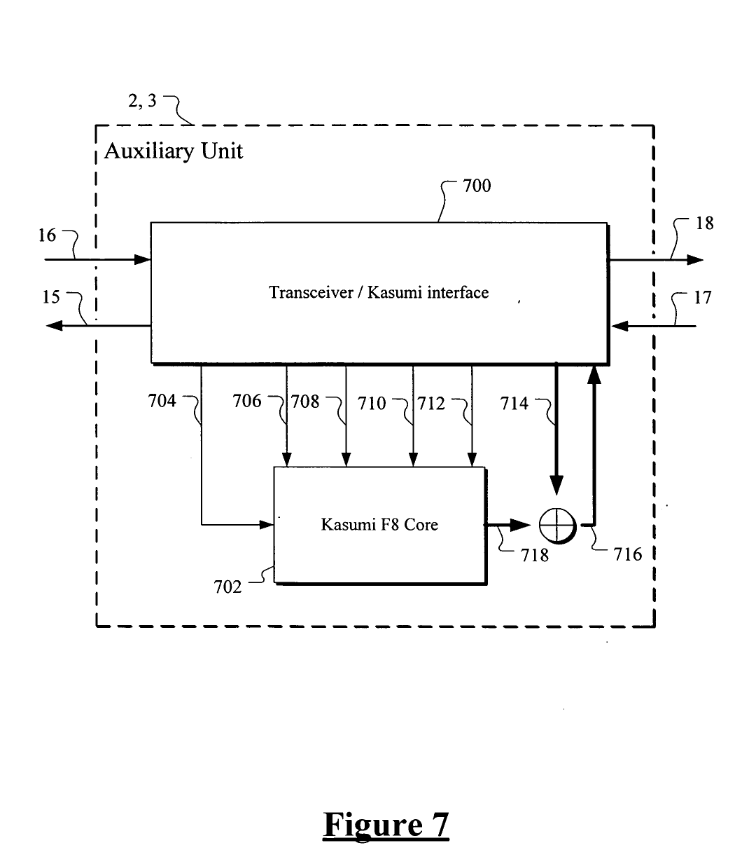

FIG. 7 illustrates an exploded view of an embodiment of auxiliary unit 2 configured for Kasumi f8 ciphering. Transceiver/Kasumi interface 700 is connected to co-processor 1 via command and result ports 16 and 15. The transceiver/Kasumi interface may optionally be connected in a dais), chain arrangement to auxiliary unit N 3 over corresponding command and result ports 18 and 17. The transceiver/Kasumi interface may also be configured to extract input parameters for the Kasumi F8 core 702 from the signal content of command port 16.

The input parameters to core 702 may include a cipher key 704, a time dependent input 706, a bearer identity 708: a transmission direction 710, and a required keystream length 712. Based on these input parameters, the core may generate output keystream 718 which can either be used to encrypt or decrypt input 714 from Transceiver/Kasumi interface 700, depending on selected encryption direction. The encrypted or decrypted signal may then be returned to Transceiver/Kasumi interface 700 for transmission to the co-processor across result port 15 or to another auxiliary unit for further processing across command port 18.

The functionality described above can also be implemented as software modules stored in a non-volatile memory, and executed as needed by a processor, after copying all or part of the software into executable RAM (random access memory). Alternatively, the logic provided by such software can also be provided by an ASIC. In case of a software implementation, the invention provided as a computer program product including a computer readable storage medium embodying computer program code—i.e. the software—thereon for execution by a computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. Electronic device, comprising:
a co-processor responsive to a message signal from a host processor, the co-processor configured for data transfer and data processing in parallel and further configured to return a message signal to the host processor once the processing is complete; and
one or more auxiliary units bi-directionally connected to the co-processor and configured to execute in whole or in part the data processing in response to a message signal from the co-processor, and further configured to return a message signal to the co-processor once the processing is complete.

2. Electronic device of claim 1 wherein the one or more auxiliary units and co-processor are configured to support multithreading and further configured to process multiple tasks in parallel.

3. Electronic device of claim 2, wherein the co-processor is configured to distribute data processing operations to the one or more auxiliary units, further wherein the co-processor is configured to continue processing other operations until the co-processor is read) to use the result of the one or more auxiliary, units' data processing.

4. Electronic device of claim 3, wherein the one or more auxiliary units are connected directly to the co-processor using a packet based interconnect.

5. Electronic device of claim 3, further comprising:
a co-processor register bank;
wherein each of the one or more auxiliary units is configured to write data processing results to the co-processor register bank,
further wherein the electronic device is configured to mark as affected those registers in the co-processor register bank utilized by the one or more auxiliary units,
further wherein the co-processor is configured to stall if the co-processor attempts to use register values that are marked as affected but have not yet been updated to reflect the results of the one or more auxiliary units' data processing.

6. Electronic device of claim 1, wherein the one or more auxiliary units comprise one or more programmable gate arrays.

7. Electronic device of claim 1, wherein the one or more auxiliary units are configured to perform an operation associated with a tag, and are further configured to return a corresponding result with the same tag.

8. Electronic device of claim 1, wherein the one or more auxiliary units are configured to execute one or more data ciphering algorithms.

9. Electronic device of claim 1, wherein the co-processor is configured to perform another task or another part of the same task if the one or more auxiliary units have not vet completed processing.

10. Electronic device of claim 1 configured for use in a mobile terminal.

11. Electronic device of claim 1, wherein each of the one or more auxiliary units are configured to process one or more data ciphering algorithms' key generating core to generate a cipher key.

12. Electronic device of claim 1 wherein the co-processor combines the cipher key generated by the auxiliary unit with ciphered data.

13. System, comprising:
one or more host processors;
one or more memory units;
a co-processor responsive to a message signal from a host processor, the co-processor configured for data transfer and data processing in parallel and further configured to return a message signal to the host processor once the processing is complete, the co-processor connected to the one or more host processors and one or more memory units via a pipelined interconnect;
one or more auxiliary units bi-directionally connected to the co-processor and configured to execute in whole or in part the data processing in response to a message signal from a host processor, and further configured to return a message signal to the co-processor once the processing is complete.

14. System of claim 13, herein the one or more auxiliary units and co-processor are configured to support multithreading and further configured to process multiple tasks in parallel.

15. System of claim 14, wherein the co-processor is configured to distribute data processing operations to the one or more auxillary units, further wherein the co-processor is configured to continue processing other operations until the co-processor is ready to use the result of the one or more auxiliary units' data processing.

16. System of claim 13, wherein the one or more auxiliary units are connected directly to the co-processor using a packet based interconnect.

17. System of claim 15, further comprising:
a co-processor register bank;
wherein each of the one or more auxiliary units is configured to write data processing results to the co-processor register bank,
further Wherein the electronic device is configured to mark as affected those registers in the co-processor register bank utilized by the one or more auxiliary units,
further wherein the co-processor is configured to stall if the co-processor attempts to use register values that are marked as affected but have not yet been updated to reflect the results of the one or more auxiliary units' data processing.

18. System device of claim 13, wherein at least one of the one or more host processors and co-processor operate in parallel.

19. System of claim 18, wherein at least one of the one or more host processors is configured to distribute data processing operations to the co-processor, further wherein the at least one of the one or more host processors is configured to continue processing other operations until ready to use the result of the co-processor's data processing.

20. Method, comprising:
receiving a message signal containing code or parameters relating to a task from a host processor to a co-processor, the co-processor configured for data transfer and data processing in parallel,
downloading the code to a memory block, or running code available in the memory block or a cache by the co-processor,
executing the task by the co-processor, and
informing the host processor of the completed task.

21. Method of claim 20, further comprising allocating a portion of the task to one or more auxiliary units for processing.

22. Method of claim 20, further comprising:
marking as affected those registers in a co-processor register bank utilized by the one or more auxiliary units,
writing the result of the processing of the portion of the task to a co-processor register bank, and
stalling the co-processor if the co-processor attempts to use register values that are marked as affected but have not yet been updated to reflect the result of the processing of the portion of the task.

23. Electronic device, comprising:
means for receiving a message signal containing code or parameters relating to a task from a host processor to a co-processor, the co-processor configured for data transfer and data processing in parallel;
means for downloading the code to a memory block, or running code available in the memory block or a cache by the co-processor:
means for executing the task by the co-processor; and
means for informing the host processor of the completed task.

24. Electronic device of claim 23, further comprising means for allocating a portion of the task to one or more auxiliary: units for processing.

25. Electronic device of claim 24, further comprising:
means for marking as affected those registers in a co-processor register bank utilized by the one or more auxiliary units,
means for Writing the result of the processing of the portion of the task to a co-processor register bank, and
means for stalling the co-processor if the co-processor attempts to use register values that are marked as affected but have not yet been updated to reflect the result of the processing of the portion of the task.
